(19) United States
(12) Patent Application Publication
(10) Pub. No.: US 2026/0351114 A1
(43) Pub. Date: Nov. 5, 2026

(54) SYSTEMS, METHODS, AND MEDIA FOR EMERGENCY MONITORING OF HIDDEN HAZARDS IN URBAN TUNNELS BASED ON INTERNET OF THINGS (IOT) LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Hongjian LIU, Chengdu (CN)

(73) Assignee: CHENGDU QINCHUAN IOT TECHNOLOGY CO., LTD., Chengdu (CN)

(21) Appl. No.: 19/710,339

(22) Filed: Jun. 16, 2026

(30) Foreign Application Priority Data
Apr. 21, 2026 (CN) 202610528907.8

(51) Int. Cl. G08G 1/123; G08G 1/0968

(52) U.S. Cl. CPC G08G 1/123; G08G 1/096833

(57) ABSTRACT

Disclosed are a system, a method, and a medium for emergency monitoring of hidden hazards in urban tunnels based on an Internet of Things (IoT) large model. The system comprises an emergency supervision management platform. The method comprises: obtaining hazardous material monitoring data based on positioning devices deployed in a target tunnel; determining a plurality of individual risk events in the target tunnel based on the hazardous material monitoring data, environmental monitoring data, and traffic monitoring data; determining cascading risk events in the target tunnel based on the plurality of individual risk events and structural information of the target tunnel; and generating a first rescue instruction including rescue paths and rescue approaches based on the plurality of individual risk events and the cascading risk events, and controlling a corresponding rescue intelligent terminal to navigate along the rescue paths based on the first rescue instruction and display the rescue approaches.

### CROSS-REFERENCE TO RELATED APPLICATIONS

This application claims priority to Chinese Application No. 202610528907.8, filed on Apr. 21, 2026, the entire contents of which are incorporated herein by reference.

### TECHNICAL FIELD

The present disclosure relates to the field of emergency monitoring, and in particular, to a system, method, and medium for emergency monitoring of hidden hazards in urban tunnels based on an Internet of Things (IoT) large model.

### BACKGROUND

As important transportation infrastructures, tunnels have the characteristics of being enclosed, long and narrow, and having a complex environment, and once an accident occurs, it is liable to cause severe casualties and property losses.

To improve the safety management level of tunnels, various intelligent systems have been developed. These intelligent systems can coordinately control ventilation, lighting, traffic signals, and broadcasting systems in a tunnel when an accident occurs to minimize the impact of the accident. However, many intelligent systems still have problems such as inaccurate positioning, isolated data, and delayed response, which are prone to cause a lack of foresight in emergency response and an inability to provide precise and visual command of rescue forces.

Therefore, it is desirable to provide a system, a method, and a medium for emergency monitoring of hidden hazards in urban tunnels based on an Internet of Things (IoT) large model, which can improve positioning accuracy of accidents, quality of safety monitoring in tunnels, and timeliness, precision, and effectiveness of emergency response.

### SUMMARY

One or more embodiments of the present disclosure provide a system for emergency monitoring of hidden hazards in urban tunnels based on an Internet of Things (IoT) large model. The system includes an emergency supervision management platform. The emergency supervision management platform is configured to: obtain hazardous material monitoring data based on positioning devices deployed in a target tunnel; determine a plurality of individual risk events in the target tunnel based on the hazardous material monitoring data, environmental monitoring data, and traffic monitoring data through a risk rule table; determine cascading risk events in the target tunnel based on the plurality of individual risk events and structural information of the target tunnel; and generate a first rescue instruction including rescue paths and rescue approaches based on the plurality of individual risk events and the cascading risk events, and control a corresponding rescue intelligent terminal to navigate along the rescue paths based on the first rescue instruction and display the rescue approaches.

One or more embodiments of the present disclosure provide a method for emergency monitoring of hidden hazards in urban tunnels based on an Internet of Things (IoT) large model. The method includes: obtaining hazardous material monitoring data based on positioning devices deployed in a target tunnel; determining a plurality of individual risk events in the target tunnel based on the hazardous material monitoring data, environmental monitoring data, and traffic monitoring data through a risk rule table; determining cascading risk events in the target tunnel based on the plurality of individual risk events and structural information of the target tunnel; and generating a first rescue instruction including rescue paths and rescue approaches based on the plurality of individual risk events and the cascading risk events, and controlling a corresponding rescue intelligent terminal to navigate along the rescue paths based on the first rescue instruction and display the rescue approaches.

One or more embodiments of the present disclosure provide a non-transitory computer-readable storage medium, comprising computer instructions that, when executed by a computer, cause the computer to implement a method for emergency monitoring of hidden hazards in urban tunnels based on an Internet of Things (IoT) large model.

### BRIEF DESCRIPTION OF THE DRAWINGS

The present disclosure will be further described by way of exemplary embodiments, which will be described in detail with reference to the accompanying drawings. These embodiments are not limiting, and in these embodiments, the same numerals refer to the same structures, wherein:

FIG. 1 is a block diagram illustrating an exemplary system for emergency monitoring of hidden hazards in urban tunnels based on an Internet of Things (IoT) large model according to some embodiments of the present disclosure;

FIG. 2 is a flowchart illustrating an exemplary method for emergency monitoring of hidden hazards in urban tunnels based on an Internet of Things (IoT) large model according to some embodiments of the present disclosure;

FIG. 3 is a schematic diagram illustrating an exemplary structure of a prediction model according to some embodiments of the present disclosure.

### DETAILED DESCRIPTION

To more clearly illustrate the technical solutions of the embodiments of the present disclosure, the accompanying drawings to be used in the description of the embodiments are briefly introduced hereinafter. Obviously, the accompanying drawings in the following descriptions are merely some examples or embodiments of the present disclosure, and a person of ordinary skill in the art may also apply the present disclosure to other similar scenarios based on these accompanying drawings without inventive effort. Unless explicitly apparent from the context or otherwise specified, identical reference numerals in the figures represent identical structures or operations.

It should be understood that the terms “system”, “device”, “unit”, and/or “module” as used herein are a manner configured to distinguish different components, elements, parts, portions, or assemblies of different levels. However, if other terms can achieve the same purpose, the aforementioned terms may be replaced by other expressions.

Flowcharts are used in the present disclosure to illustrate operations performed by a system according to embodiments of the present disclosure. It should be understood that the preceding or following operations are not necessarily performed precisely in the indicated order. Rather, the individual operations may be processed in reverse order or concurrently. Meanwhile, other operations may also be added to these processes, or one or more operations may be removed from these processes.

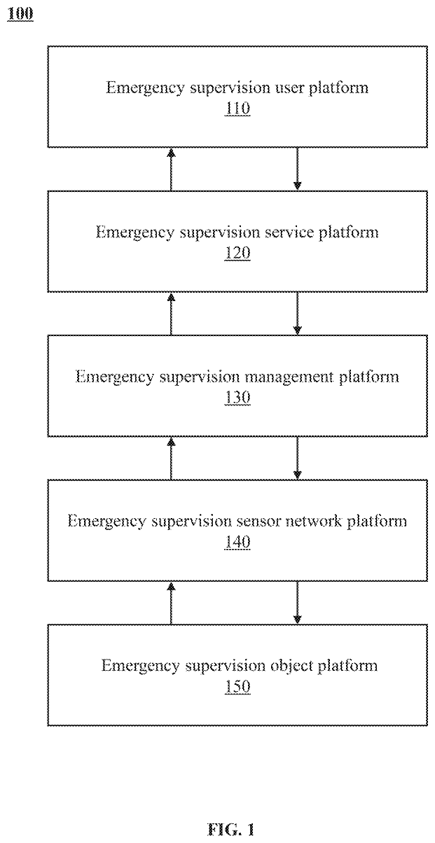

FIG. 1 is a block diagram illustrating an exemplary system for emergency monitoring of hidden hazards in urban tunnels based on an Internet of Things (IoT) large model according to some embodiments of the present disclosure.

In some embodiments, a system 100 for emergency monitoring of hidden hazards in urban tunnels based on an IoT large model includes: an emergency supervision user platform 110, an emergency supervision service platform 120, an emergency supervision management platform 130, an emergency supervision sensor network platform 140, and an emergency supervision object platform 150.

The IoT large model refers to an IoT model architecture configured to achieve efficient circulation of a large amount of data in the system 100. In some embodiments, artificial intelligence (AI) models (e.g., ChatGPT and Gemini) may be applied to the IoT model architecture for the sensing and processing of data.

The emergency supervision user platform 110 refers to a platform configured to interact with users (e.g., supervisory personnel). In some embodiments, the emergency supervision user platform 110 includes a terminal device. For example, the terminal device may include a mobile device, a tablet computer, a console, or the like. The emergency supervision user platform 110 may perform two-way data exchange with the emergency supervision service platform 120.

The emergency supervision service platform 120 refers to a platform configured to receive and transmit data and/or information. In some embodiments, the emergency supervision service platform 120 may be configured as a server, a processor, or a communication module. The emergency supervision service platform 120 may perform two-way interaction with the emergency supervision user platform 110 and the emergency supervision management platform 130. The communication module refers to a device or software configured to achieve real-time information interaction. For example, the communication module may be a mobile phone, a video monitor, a multimedia computer, or the like.

The emergency supervision service platform 120 may perform two-way interaction with a data center of the emergency supervision management platform 130. In some embodiments, the emergency supervision management platform 130 may obtain monitoring data from the emergency supervision object platform 150 through the emergency supervision sensor network platform 140, and store the obtained monitoring data to a database.

The emergency supervision management platform 130 (hereinafter referred to as a management platform) refers to a comprehensive management platform configured to manage and coordinate connections and collaborations among a plurality of platforms. The management platform may be configured as a server or a processor. In some embodiments, the management platform 130 may communicate with the emergency supervision object platform 150 through the data center and the emergency supervision sensor network platform 140.

In some embodiments, the management platform 130 may include the data center. The data center may include a database, a data processing model library, and a computing unit.

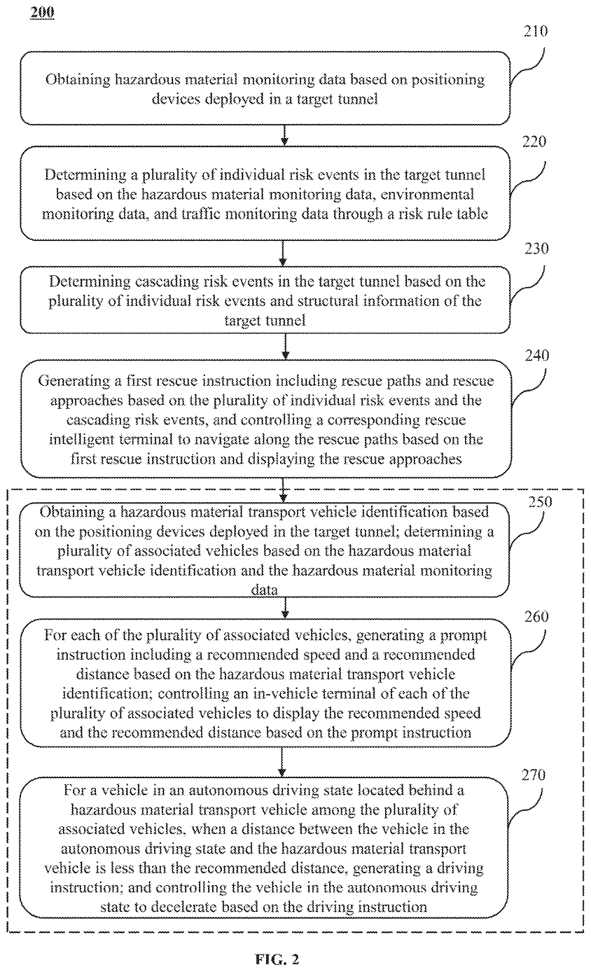

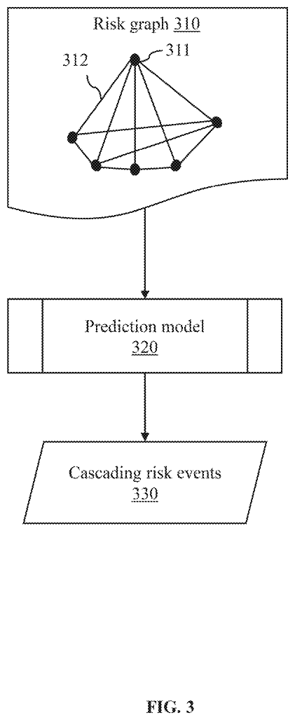

The database is configured to collect, store, and manage data (e.g., hazardous material monitoring data, environmental monitoring data, traffic monitoring data, or the like) related to emergency monitoring of the hidden hazards in the urban tunnels. The database may include MySQL, PostgreSQL, InfluxDB, Prometheus, or the like. More descriptions regarding the hazardous material monitoring data, the environmental monitoring data, and the traffic monitoring data may be found elsewhere in the present disclosure (e.g., FIGS. 2-3 and the related descriptions thereof).

The data processing model library is configured to store trained data processing large models. In some embodiments, the data processing model library may include a chatbot, a risk identification model, a prediction model, or the like. More descriptions regarding the prediction model may be found elsewhere in the present disclosure (e.g., FIG. 3 and the related descriptions thereof).

The computing unit refers to a functional module configured to perform arithmetic, logic, and other instruction operations. The computing unit may include a processor.

In some embodiments, the emergency supervision management platform 130 is configured to: obtain the hazardous material monitoring data based on positioning devices deployed in a target tunnel; determine a plurality of individual risk events in the target tunnel based on the hazardous material monitoring data, the environmental monitoring data, and the traffic monitoring data through a risk rule table; determine cascading risk events in the target tunnel based on the plurality of individual risk events and structural information of the target tunnel; and generate a first rescue instruction including rescue paths and rescue approaches based on the plurality of individual risk events and the cascading risk events, and control a corresponding rescue intelligent terminal to navigate along the rescue paths based on the first rescue instruction and display the rescue approaches.

More descriptions regarding the emergency supervision management platform may be found elsewhere in the present disclosure (e.g., FIGS. 2-3 and the related descriptions thereof).

The emergency supervision sensor network platform 140 is configured to comprehensively manage sensing information, and refers to a communication transmission platform configured to achieve two-way data interaction between the emergency supervision management platform 130 and the emergency supervision object platform 150. In some embodiments, the emergency supervision sensor network platform 140 may be configured as a communication network, a gateway, or other devices. The emergency supervision sensor network platform 140 is responsible for uploading real-time sensing data collected by the emergency supervision object platform to the emergency supervision management platform 130, and issuing the first rescue instruction generated by the emergency supervision management platform 130 to the corresponding emergency supervision object platform 150 for performing operations.

The emergency supervision object platform 150 refers to a platform configured for supervision information generation and control information execution. In some embodiments, the emergency supervision object platform 150 may include various sensors deployed at key tunnel nodes (e.g., gas sensors, smoke concentration sensors, and water level sensors), ultra-wideband (UWB) positioning base stations, rescue intelligent terminals, in-vehicle terminals of associated vehicles, associated vehicles in an autonomous driving state, ventilation devices, indication devices, or the like. The emergency supervision object platform 150 is responsible for collecting real-time data of the hazardous material monitoring data, the environmental monitoring data, the traffic monitoring data, or the like, and uploading the real-time data through the emergency supervision sensor network platform 140. Meanwhile, the emergency supervision object platform 150 responds to the first rescue instruction issued by the emergency supervision management platform 130, and performs specific emergency operations, such as controlling the corresponding rescue intelligent terminal to navigate along the rescue paths based on the first rescue instruction.

In some embodiments of the present disclosure, by integrating UWB precision positioning, a cascading prediction model, and a dynamic digital twin platform through the system for emergency monitoring of the hidden hazards in the urban tunnels based on the IoT large model, the system can solve problems of unclear emergency positioning and hard-to-predict risks in confined spaces (e.g., tunnels).

FIG. 2 is a flowchart illustrating an exemplary method for emergency monitoring of hidden hazards in urban tunnels based on an Internet of Things (IoT) large model according to some embodiments of the present disclosure. As shown in FIG. 2, a process 200 includes the following operations. In some embodiments, the process 200 may be executed by an emergency supervision management platform.

In 210, obtaining hazardous material monitoring data based on positioning devices deployed in a target tunnel.

The target tunnel refers to a tunnel that requires monitoring and risk management. Hereinafter, the target tunnel is also referred to as a tunnel.

The positioning devices are configured to position target vehicles passing through the target tunnel. For example, the positioning devices include radars. The target vehicles include a vehicle transporting hazardous materials (hereinafter referred to as a hazardous material transport vehicle).

In some embodiments, the positioning devices are UWB positioning base stations. The UWB positioning base stations are devices that utilize an ultra-wideband radio technology for high-precision positioning.

In some embodiments, within the target tunnel, a plurality of UWB positioning base stations are deployed on a side wall or a top of the tunnel at a preset spacing. The plurality of UWB positioning base stations are connected through a wired network to form an UWB positioning network covering an interior of the tunnel. When vehicles with UWB tags enter the tunnel, the UWB positioning network provides continuous and accurate position data.

The hazardous material monitoring data refers to positioning information of a plurality of hazardous material transport vehicles obtained within a preset period. For example, the hazardous material monitoring data includes real-time three-dimensional coordinates of the hazardous material transport vehicles in the tunnel and their continuous driving trajectory data.

The preset period refers to a period of time calculated backward from a current moment. A duration of the preset period may be set based on an actual application or prior experience (e.g., 3 m, 5 m, or the like).

The hazardous material monitoring data may be obtained in a plurality of ways. For example, the management platform obtains the hazardous material monitoring data by obtaining positioning signals of global positioning systems (GPS) of the hazardous material transport vehicles.

In some embodiments, the hazardous material monitoring data is obtained in the following manner. Designated hazardous material transport vehicles and critical vehicles (e.g., buses) are equipped with the UWB tags; when vehicles equipped with the UWB tags enter the target tunnel, the UWB tags on the vehicles actively emit UWB signals; after the plurality of UWB positioning base stations pre-deployed in the target tunnel receive the signals, real-time three-dimensional coordinates of the UWB tags are determined based on time differences of signal arrival at different base stations by utilizing a time difference of arrival (TDOA) algorithm; and by continuously collecting and processing the real-time three-dimensional coordinates, the driving trajectory data of the hazardous material transport vehicles in the tunnel is generated as the hazardous material monitoring data.

In 220, determining a plurality of individual risk events in the target tunnel based on the hazardous material monitoring data, environmental monitoring data, and traffic monitoring data through a risk rule table.

The environmental monitoring data refers to data obtained within the preset period, reflecting environmental conditions inside the tunnel. In some embodiments, the environmental monitoring data includes temperature data, a carbon monoxide (CO) concentration, a nitrogen oxide (NOx) concentration, a smoke concentration, a water accumulation depth, or the like.

The environmental monitoring data may be obtained by a plurality of sensors deployed in the target tunnel. For example, the temperature data, the CO concentration, the NOx concentration, and the smoke concentration may be obtained through real-time acquisition by temperature-sensitive fire detectors, CO and NOx gas sensors, and smoke concentration sensors, respectively, which are deployed on a longitudinal top or a side wall of the target tunnel. The water accumulation depth may be obtained through real-time monitoring by pressure-type water level sensors deployed at positions prone to water accumulation (e.g., a lowest point, a sump, a drainage pump station, or the like) of the tunnel.

The traffic monitoring data refers to data obtained within the preset period, reflecting traffic operating conditions inside the tunnel. The traffic monitoring data includes vehicle image streams, a vehicle flow, an average vehicle speed, a lane occupancy rate, or the like. The traffic monitoring data may be obtained in the plurality of ways.

In some embodiments, the management platform inputs high-definition image streams obtained by high-definition cameras deployed along the tunnel into an image recognition algorithm to obtain the traffic monitoring data. The image recognition algorithm may include a convolutional neural network (CNN), an object detection algorithm, or the like.

In some embodiments, to compensate for the problem of data loss when the high-definition cameras have low visibility (e.g., due to smoke and insufficient light) in the tunnel, millimeter-wave radars may be provided in the tunnel and configured to obtain the traffic monitoring data. The millimeter-wave radars are not affected by environmental factors such as illumination, smoke, or the like, and can accurately detect speeds and driving directions of a plurality of vehicles on a plurality of lanes, accurately monitoring the traffic monitoring data.

The individual risk event refers to a risk event that may occur independently in the target tunnel and is not affected by other risk events. The individual risk event includes a risk type and risk information.

The risk type refers to a type of a risk event. The risk type includes environmental risk events, traffic risk events, and transport risk events. The environmental risk events include water accumulation, waterlogging, fire inside the tunnel, or the like. The traffic risk events include vehicle collisions, wrong-way driving, vehicle breakdowns, or the like. The transport risk events include collision, explosion, or leakage of the hazardous material transport vehicles occurring in the tunnel, or the like.

The risk information refers to specific information related to a risk event. For example, the risk information includes a location where a risk event occurs and a risk level of the risk event.

In some embodiments, the processor determines the plurality of individual risk events in the target tunnel by retrieving or querying in the risk rule table based on the hazardous material monitoring data, the environmental monitoring data, and the traffic monitoring data.

The risk rule table includes a mapping relationship between the environmental monitoring data, the traffic monitoring data, and the hazardous material monitoring data and whether various individual risk events (e.g., the environmental risk events, the traffic risk events, and the transport risk events) will occur.

In some embodiments, the risk rule table may include, but is not limited to, the following exemplary rules or mapping relationships.

For example, a rule for identifying the environmental risk events is as follows. When the water accumulation depth exceeds a preset water accumulation threshold, the individual risk event is determined as water accumulation or waterlogging; when a temperature rise rate of the temperature data exceeds a preset temperature rise threshold, the individual risk event is determined as fire.

As another example, a rule for identifying the transport risk events is as follows. When UWB positioning data of the hazardous material transport vehicle overlaps in time and space with a traffic event that has been determined as “collision” or “breakdown”, the individual risk event is determined as a collision or breakdown of the hazardous material transport vehicle.

In some embodiments, the risk rule table is determined based on a plurality of pieces of historical accident data in the following operations. First, a plurality of cluster vectors are constructed based on the plurality of historical accident data, and a historical accident type corresponding to each of the plurality of cluster vectors is determined; the plurality of cluster vectors are clustered through a clustering algorithm (e.g., K-Means clustering, DBSCAN, or the like) based on the historical accident type to determine one or a plurality of clusters; for each of the plurality of clusters, the management platform obtains monitoring data with significant differences from a normal state among all the cluster vectors, and uses the monitoring data as features for constructing the risk rule table. For each type of the monitoring data with significant differences, a mean (μ) and a standard deviation (σ) of the monitoring data of all the cluster vectors in the cluster are obtained, and μ±σ*N is used as a data range corresponding to this type of monitoring data in this type of accident in the risk rule table. N is a positive integer.

The historical accident data refers to historical data when an accident occurs in the tunnel. The historical accident data includes historical risk types, historical risk information, and hazardous material monitoring data, environmental monitoring data, and traffic monitoring data (hereinafter referred to as historical hazardous material data, historical environmental data, and historical traffic data, respectively) when a historical accident occurs.

The specific contents of the historical accident types and the historical risk information are similar to the risk type and the risk information.

Data of the normal state may be preset by technical personnel based on experience. Data of the normal state for each type of the historical risk types may be different.

The clustering algorithm is capable of classifying accidents with similar data patterns into a type, thereby obtaining a plurality of clusters, where each of the plurality of clusters corresponds to a specific accident type. By analyzing data patterns of the historical accident data, the risk rule table is obtained, and relatively accurate determination rules can be obtained.

In some embodiments, the emergency supervision management platform is further configured to: update the risk rule table every preset period based on the historical hazardous material data, the historical environmental data, and the historical traffic data through a risk identification model.

The preset period refers to an update period of the risk rule table. A duration of the preset period may be set based on experience (e.g., 2 h, 5 h, or the like).

In some embodiments, the risk identification model may be a machine learning model, such as any one of a deep neural network (DNN) model, other customized model structures, or the like, or any combination thereof.

An input of the risk identification model includes the historical hazardous material data, the historical environmental data, and the historical traffic data within a previous preset period of a current moment. An output of the risk identification model includes the risk rule table.

In some embodiments, the risk identification model may be trained through a plurality of first training samples with first labels. For example, the plurality of first training samples with the first labels may be input into an initial risk identification model, a loss function is constructed based on the first labels and results of the initial risk identification model, and parameters of the initial risk identification model are iteratively updated based on the loss function through gradient descent or other manners. When preset conditions are satisfied, the model training is completed, and a trained risk identification model is obtained. The preset conditions may be convergence of the loss function, a count of iterations reaching a threshold, or the like.

In some embodiments, the first training samples may include the historical hazardous material data, the historical environmental data, and the historical traffic data within a plurality of historical preset periods. The first training samples may be obtained based on historical data.

In some embodiments, the first labels may include the risk rule table within a next update period of a historical update period corresponding to the first training samples. The first labels may be constructed in the following manner: obtaining a historical numerical range (i.e., a maximum value to a minimum value) of historical monitoring data with significant differences from the normal state for each accident type when an accident actually occurs within the next update period of the historical update period; and constructing a historical risk rule table as the first label based on the historical numerical range.

The historical monitoring data includes the hazardous material monitoring data, the environmental monitoring data, and the traffic monitoring data.

In some embodiments of the present disclosure, determining the risk rule table based on the historical hazardous material data, the historical environmental data, and the historical traffic data through the trained risk identification model can make the risk rule table more aligned with reality, thereby effectively ensuring the accuracy rate of identifying the individual risk events.

In some embodiments, the management platform determines, through the risk rule table, a similarity between current hazardous material monitoring data, current environmental monitoring data, and current traffic monitoring data and corresponding determination rules in the risk rule table, and uses the similarity as a risk level of a corresponding risk event.

A calculation manner of the similarity may be implemented in a plurality of ways. Taking temperature data as an example, if a temperature range corresponding to the preset rule table is A to B, and a current temperature is C, then the similarity is |C-A|/A.

A location where the individual risk event occurs may be a location of a risk event identified based on the environmental monitoring data, the traffic monitoring data, the hazardous material monitoring data, or the like.

In 230, determining cascading risk events in the target tunnel based on the plurality of individual risk events and structural information of the target tunnel.

The structural information refers to geometric structural data and physical attribute data of the target tunnel. For example, the structural information includes an inner diameter of the tunnel, a tunnel height, a ventilation system layout, a fire-fighting facility distribution, or the like. The structural information may be obtained through design drawings, construction archives, completion documents, or on-site measurement and exploration.

The cascading risk event refers to a secondary or derivative risk event triggered by one individual risk event or a plurality of individual risk events. The cascading risk event, compared to the individual risk event, may result in a larger damage scope and more severe consequences. The cascading risk event includes a cascading risk type, a predicted risk time point, and a risk location (also referred to hereinafter as an occurrence time point and an occurrence location). The cascading risk type includes a tunnel structural damage risk, a personnel asphyxiation risk, a large-scale hazardous material leakage and diffusion risk, or the like. The predicted risk time point and the risk location refer to when and which specific regions the predicted cascading risk event will affect.

For example, if the individual risk event is a fire, the cascading risk event that may be triggered includes tunnel structural damage, smoke spread causing personnel asphyxiation, reduced visibility triggering secondary traffic accidents, or the like. If the individual risk event is a hazardous material leakage, it may cause large-area pollution, an explosion, or the like.

The management platform may determine the cascading risk events in the target tunnel based on the plurality of individual risk events and the structural information of the target tunnel in a plurality of ways.

In some embodiments, the management platform may determine the cascading risk events in the following operations.

Cluster vectors are constructed based on a plurality of historical individual risk events recorded at a plurality of historical moments in the target tunnel and corresponding historical structural data. Labels of the cluster vectors are types, occurrence time points, and occurrence locations of actually occurred historical risk events within a subsequent period of time (e.g., 0.5 h, 1 h, 2 h, or the like) corresponding to historical moments. Target vectors are constructed based on a plurality of current individual risk events and current structural data. The plurality of cluster vectors and the plurality of target vectors are clustered to obtain a plurality of clusters. Clusters containing the target vectors are designated as target clusters. A union of types, occurrence time points, and occurrence locations of actually occurred historical risk events corresponding to all cluster vectors in the target clusters is taken as the plurality of cascading risk events corresponding to the target vectors.

In 240, generating a first rescue instruction including rescue paths and rescue approaches based on the plurality of individual risk events and the cascading risk events, and controlling a corresponding rescue intelligent terminal to navigate along the rescue paths based on the first rescue instruction and displaying the rescue approaches.

The rescue path refers to a planned travel route for the rescue personnel to travel from a tunnel entrance or a designated assembly point to the risk location. For example, the rescue path involves driving from a tunnel A entrance along a left lane to chainage K, or arriving at the risk location through an emergency passage in the tunnel.

The rescue approach refers to specific rescue actions and technical means taken by the rescue personnel after arriving at the risk location for a specific risk event. For example, for a fire, the rescue approach may be: “the rescue personnel holding a thermal imaging camera (TIC) and a lighting tool perform a “Z”-shaped search along a tunnel side wall (e.g., using a right-hand rule) to search for trapped personnel”, and “using a high-pressure water gun or a foam gun to strike and extinguish the fire by aiming at the root of flame”.

The management platform may generate the first rescue instruction in various ways. In some embodiments, the management platform, based on a plurality of currently identified individual risk events and cascading risk events, randomly assigns pending risk events to each rescue team; and determines, based on the structural information of the target tunnel, an optimal rescue path from a current location (or a designated entrance) of the rescue personnel to the risk location by utilizing a shortest path planning algorithm (e.g., Floyd, Bellman-Ford, or the like). One rescue team may be assigned to handle one or more events, and each rescue team may include a plurality of rescue personnel.

In some embodiments, the management platform determines the rescue approach by querying a rescue approach preset table. The rescue approach preset table includes standard rescue approaches and operating procedures corresponding to various types of risk events (including the individual risk events and the cascading risk events). The management platform retrieves corresponding rescue approaches from the rescue approach preset table based on determined risk types.

The rescue intelligent terminal corresponding to the rescue instruction refers to an intelligent device worn or carried by the rescue personnel when performing rescue tasks, and configured to receive, display, and execute the rescue instruction. For example, the rescue intelligent terminal includes a smart helmet, a smartphone, a smartwatch, or the like.

In some embodiments, the management platform may determine the rescue instruction by constructing a risk digital twin model. More descriptions may be found elsewhere in the present disclosure (e.g., FIG. 3 and the related descriptions thereof).

In some embodiments of the present disclosure, in a tunnel where GPS cannot be used, by deploying sensors such as temperature, gas, and water level sensors, or the like, in combination with the high-definition cameras and the UWB positioning technology, the environmental monitoring data, the traffic monitoring data, and the hazardous material monitoring data in the tunnel are identified, thereby providing critical location data for subsequent risk analysis.

In some embodiments, the process 200 further includes operations 250-270.

In 250, obtaining a hazardous material transport vehicle identification based on the positioning devices deployed in the target tunnel; determining a plurality of associated vehicles based on the hazardous material transport vehicle identification and the hazardous material monitoring data.

The hazardous material transport vehicle identification reflects a type of hazardous material (hereinafter referred to as a hazardous material type) and a transport volume transported by a hazardous material transport vehicle. For example, the hazardous material transport vehicle identification may be represented as “flammable liquid, 10 t” or “highly toxic gas, 5 t”.

The management platform may directly obtain the hazardous material transport vehicle identification from a UWB tag equipped on a vehicle. For example, the UWB tag includes a vehicle ID of the vehicle, the hazardous material type, the transport volume, or the like.

The associated vehicle refers to a vehicle that may be involved in an accident with the hazardous material transport vehicle or may be affected by the hazardous material transport vehicle. For example, the associated vehicle is a vehicle within a preset distance range of the hazardous material transport vehicle.

The management platform may determine the associated vehicles in various ways. For example, the management platform takes vehicles with a distance to the hazardous material transport vehicle within the preset distance range as an associated vehicle set. The preset distance range may be determined based on a first preset table. The first preset table may include preset distance ranges that may be affected by leakage or combustion of different hazardous material types and transport volumes. The first preset table may be constructed by technical personnel based on prior experience. For example, a corresponding hazard distance range for each hazardous material type and transport volume is taken as the preset distance range.

In 260, for each of the plurality of associated vehicles, generating a prompt instruction including a recommended speed and a recommended distance based on the hazardous material transport vehicle identification; controlling an in-vehicle terminals of each of the plurality of associated vehicles to display the recommended speed and the recommended distance based on the prompt instruction.

The recommended speed refers to a speed at which the associated vehicles are recommended to travel. The recommended distance refers to a distance that the associated vehicles are recommended to maintain between the associated vehicles and the hazardous material transport vehicle, or among the associated vehicles. For example, when the hazardous material transport vehicle identification is “flammable liquid, 10 t”, the management platform may recommend that the associated vehicles travel at a speed of 50 km per hour and maintain a distance of 80 m from the hazardous material transport vehicle.

In some embodiments, the management platform may determine the prompt instruction in a plurality of ways. For example, the management platform may construct a target vector based on a current hazardous material transport vehicle identification; and determine the prompt instruction based on a retrieval result of the target vector in a first vector database. The first vector database may include a plurality of reference vectors and a prompt instruction corresponding to each of the plurality of reference vectors.

The reference vectors are constructed based on a plurality of historical hazardous material transport vehicle identifications. A label corresponding to each of the reference vectors is determined in the following manner. For historical hazardous material transport vehicles corresponding to the historical hazardous material transport vehicle identifications, a historical speed and a historical distance with a lowest count of accidents, among a plurality of historical speeds and historical distances during travel, are taken as the corresponding label. The management platform may determine a vector distance between the target vectors and the reference vectors, and select a label corresponding to a reference vector with a smallest vector distance as the prompt instruction.

In 270, for a vehicle in an autonomous driving state located behind a hazardous material transport vehicle among the plurality of associated vehicles, when a distance between the vehicle in the autonomous driving state and the hazardous material transport vehicle is less than the recommended distance, generating a driving instruction; and controlling the vehicle in the autonomous driving state to decelerate based on the driving instruction.

The management platform may determine a positional relationship with the hazardous material transport vehicle based on positioning information of the associated vehicles, and confirm whether the vehicles are in an autonomous driving mode through an operating state reported by the vehicles.

In some embodiments, when it is determined that an associated vehicle behind the hazardous material transport vehicle is in the autonomous driving mode and a distance between the associated vehicle and the hazardous material transport vehicle is less than the recommended distance, the management platform generates the driving instruction based on a current speed of the vehicle in the autonomous driving mode and an actual distance between the vehicle in the autonomous driving mode and the hazardous material transport vehicle. The driving instruction may include a target speed after deceleration. The management platform sends the driving instruction to a control system of the vehicle in the autonomous driving mode, and controls the vehicle in the autonomous driving mode to travel at the target speed after decelerating.

By determining the associated vehicles, selecting vehicles with higher risk among the associated vehicles, and generating the driving instruction, the distance between the associated vehicles and the hazardous material transport vehicle can be increased, thereby further reducing the occurrence probability of the cascading risk events.

FIG. 3 is a schematic diagram illustrating an exemplary structure of a prediction model according to some embodiments of the present disclosure.

In some embodiments, the management platform is further configured to: predict cascading risk events in a target tunnel based on a plurality of individual risk events and structural information through a prediction model; the prediction model being a Graph Neural Network (GNN) model.

In some embodiments, as shown in FIG. 3, a prediction model 320 may be a graph neural network (GNN) model.

In some embodiments, an input of the prediction model includes a risk graph 310. Nodes 311 of the risk graph 310 are a plurality of individual risk events, and node features include a risk type and risk information corresponding to each of the individual risk events.

In some embodiments, when a distance between two individual risk events is less than a preset distance threshold, an edge 312 is connected between the two individual risk events. In some embodiments, when a coincidence rate of monitoring data types corresponding to risk determination rules of two individual risk events in a risk rule table is greater than a preset coincidence rate threshold, the edge 312 is connected between the two individual risk events. The preset distance threshold and the preset coincidence rate threshold may be preset based on experience. Edge features include a distance between two individual risk events and monitoring data types where risk determination rules of the two individual risk events coincide, or a time difference between occurrence times of the two individual risk events. The time difference may be obtained through a timestamp difference of the monitoring data.

An output of the prediction model 320 includes cascading risk events 330.

In some embodiments, the prediction model 320 may be obtained by training with second training samples and second labels. The second training samples constructed from historical risk graphs of different tunnels at a plurality of historical moments. The second labels include risk types, occurrence time points, and occurrence locations of actually occurred historical risk events within a subsequent period of time corresponding to the historical moments of the second training samples. A duration of the subsequent period of time may be preset. A training process of the prediction model is similar to a training process of the risk identification model. More descriptions regarding the risk identification model may be found elsewhere in the present disclosure (e.g., FIG. 2 and the related descriptions thereof).

By predicting the cascading risk events using the trained prediction model and the risk graph, it helps the system more accurately identify potential complex risk scenarios, thereby enhancing the foresight and response capability of tunnel risk management.

In some embodiments, the management platform is further configured to: generate, based on the cascading risk events, the structural information, and a ventilation device distribution, a ventilation control instruction including a ventilation speed and a ventilation direction; and control a corresponding jet fan to operate at the ventilation speed and in the ventilation direction based on the ventilation control instruction to ventilate the target tunnel.

Ventilation devices refer to devices disposed in the tunnel and configured for ventilation. For example, the ventilation devices include a jet fan. The ventilation device distribution refers to a distribution status of the ventilation devices in the tunnel. The ventilation device distribution may be preset by technical personnel. The ventilation speed refers to a rotation speed of a ventilation device. The ventilation direction refers to an orientation of the ventilation device. That is, the ventilation direction determines in which direction the ventilation device performs ventilation.

The management platform may determine the ventilation control instruction in a plurality of ways. For example, the management platform obtains a ventilation speed of each ventilation device based on a second preset table, the second preset table including ventilation speeds corresponding to the cascading risk events; and for each ventilation device, the management platform determines a ventilation direction of the ventilation device based on a positional relationship between the ventilation device and an occurrence location of the cascading risk events in the structural information. For example, the ventilation direction is a direction for drawing air from the occurrence location of the cascading risk events towards a preset region (e.g., a preset safe and harmless region). The second preset table may be constructed by technical personnel based on prior experience.

In some embodiments of the present disclosure, controlling the ventilation device based on the ventilation control instruction can reduce the impact of disasters. For example, during a fire, smoke can be reduced, avoiding obstructing the line of sight of vehicles, thereby mitigating disaster losses caused by accidents.

In some embodiments, the management platform is further configured to: determine a high-risk region based on the plurality of individual risk events and the cascading risk events; determine a crowd gathering point based on the traffic monitoring data; generate a lighting control instruction including a display color and a flashing frequency based on the crowd gathering point and the high-risk region, and control a lighting device in a corresponding region to illuminate with the display color and flash at the flashing frequency based on the lighting control instruction; and generate a lighting indication instruction including an indication sign based on the crowd gathering point and the high-risk region, and control a corresponding indication device to display the indication sign based on the lighting indication instruction.

The high-risk region refers to a region with a high incidence of risk events. The high-risk region may be determined by statistically determining a count of individual risk events and cascading risk events for each region of the tunnel. For example, the target tunnel may be evenly divided into a plurality of regions, a count of individual risk events and cascading risk events within each region may be statistically determined, and a region where the count exceeds a preset quantity threshold may be determined as the high-risk region. The preset quantity threshold may be preset based on experience.

The crowd gathering point refers to a region where crowds gather in the target tunnel. For example, the crowd gathering point may be a region where a pedestrian flow or a vehicle flow is greater than a flow threshold.

In some embodiments, the crowd gathering point may be determined based on the traffic monitoring data. For example, the management platform may obtain a plurality of regions where the vehicle flow is greater than a preset vehicle flow threshold or a plurality of regions where the pedestrian flow is greater than a preset pedestrian flow threshold based on high-definition image streams in the traffic monitoring data through an image recognition algorithm, and determine the regions as the crowd gathering point. The preset vehicle flow threshold and the preset pedestrian flow threshold may be preset based on experience.

The lighting control instruction includes the display color and the flashing frequency of the display device. The lighting control instruction is configured to control the display device in the tunnel to provide a warning or lighting. The display device includes a display screen in the tunnel, an indicator light, or the like. The display color refers to a color displayed by the display device, such as red representing an emergency hazard, green representing safety, or the like. The flashing frequency refers to a frequency at which the display device flashes. For example, the higher the flashing frequency, the more urgent the hazard it represents.

The management platform may determine the lighting control instruction in a plurality of ways. The management platform may be configured to generate the lighting control instruction including the display color and the flashing frequency based on the crowd gathering point and the high-risk region through a third preset table. The third preset table may include the lighting control instruction corresponding to the crowd gathering point and the high-risk region. The third preset table may be constructed in the following way. For a region that is the high-risk region and the crowd gathering point, the region is displayed in red and flashes at a first flashing frequency for warning; in other low-risk regions, the regions are displayed in green and flash at a second flashing frequency for lighting. The first flashing frequency and the second flashing frequency may be preset based on experience, and the first flashing frequency may be greater than the second flashing frequency.

The lighting indication instruction is configured to control the indication device to provide rescue guidance. For example, the lighting indication instruction includes an indication arrow sign for guiding personnel to evacuate towards a safe region, a rescue sign (e.g., a dangerous region sign and a rescue path guidance sign) for guiding rescue personnel to perform relevant rescue operations, or the like.

The lighting indication instruction may be determined in the following ways. The management platform generates a lighting indication sign pointing from the high-risk region and/or the crowd gathering point to the safe region based on location information of the crowd gathering point, the high-risk region, and location information of the safe region. For example, the generated indication arrow sign points to the safe region, thereby guiding the crowd to the safe region.

By controlling devices in the tunnel through a plurality of instructions, it is possible to quickly guide the crowd to the safe region, thereby facilitating timely evacuation of the crowd and reducing accident losses.

In some embodiments, the emergency supervision management platform is further configured to: construct a risk digital twin model based on the plurality of individual risk events, the structural information, the cascading risk events, and rescue positioning data; and send the risk digital twin model to an emergency supervision user platform, and receive a second rescue instruction sent by the emergency supervision user platform.

The rescue positioning data refers to positioning data of rescue personnel or rescue supplies. In some embodiments, the rescue personnel and/or rescue supplies may be equipped with UWB tags, and the rescue positioning data may be obtained through deployed UWB positioning base stations. The content of the second rescue instruction is similar to the first rescue instruction, where the difference lies in that the second rescue instruction is sent by a rescue commander through the emergency supervision user platform.

A digital twin model refers to a model that maps real-time data of a physical object to a virtual model through sensors and data acquisition technologies to realize real-time monitoring and management of the physical object.

The risk digital twin model refers to a three-dimensional (3D) visualization platform that reproduces a real tunnel in a 1:1 scale. At corresponding positions in the tunnel, the risk digital twin model is marked with risk types and risk information of the individual risk events, risk types and occurrence times of the cascading risk events, and real-time rescue positioning data.

Merely by way of example, the risk digital twin model may be constructed in the following way: performing 3D modeling and simulation based on the structural information of the target tunnel, and establishing the 3D visualization platform; and marking and displaying various related information such as the individual risk events, the cascading risk event, the rescue personnel, or the rescue supplies in the tunnel on the 3D visualization platform according to their positions and degrees in the real tunnel, or the like.

After the risk digital twin model is constructed, the management platform sends the risk digital twin model to the emergency supervision user platform. This allows the rescue commander to intuitively view a real-time distribution and dynamics of each rescue personnel, vehicle, risk point, and predicted risk point through the risk digital twin model on the emergency supervision user platform. The management platform may receive various second rescue instructions (including rescue paths and rescue approaches) formulated and issued by the rescue commanders based on the risk digital twin model, or directly generate the first rescue instruction based on an actual tunnel situation reflected by the risk digital twin model by path planning, or the like, and send the rescue instruction to a rescue intelligent terminal of each rescue personnel through the emergency supervision object platform, thereby improving the flexibility and reliability of the rescue instruction.

In some embodiments, the risk digital twin model further includes real-time environmental data.

In some embodiments, the management platform is further configured to: during a rescue, determine a detour region based on the risk digital twin model; the detour region including a region with abnormal real-time environmental data and/or a region associated with the cascading risk events; determine the rescue paths of the rescue personnel based on the detour region, a rescue equipment allocation status of the rescue personnel, and a distance between the rescue personnel and each of the plurality of individual risk events; for each of the rescue paths, generate a navigation instruction including a navigation indication and a navigation color; and control an indication device on the rescue path to display the navigation indication in the navigation color based on the navigation instruction.

The real-time environmental data refers to environmental monitoring data of each location point at a current moment. For example, the real-time environmental data includes real-time temperature data, a real-time smoke concentration, or the like.

The detour region refers to a region that needs to be detoured. The detour region includes the region with the abnormal real-time environmental data and/or the region associated with the cascading risk events. The region with the abnormal real-time environmental data refers to a region in the tunnel where the real-time monitoring data is abnormal, such as a high-temperature region or a dense smoke region.

The management platform may determine a region where the real-time temperature data exceeds a preset temperature threshold, and a region where a smoke concentration in the real-time smoke concentration exceeds a preset concentration threshold reflected by the risk digital twin model as the region with the abnormal real-time environmental data. The preset temperature threshold and the preset concentration threshold may be preset based on experience.

The region associated with the cascading risk events refers to a region where an occurrence location of the cascading risk event is located or a region that may be endangered by the cascading risk event.

In some embodiments, the management platform may determine a region corresponding to the occurrence location of the cascading risk event and a region within a preset influence distance from the occurrence location of the cascading risk event as the region associated with the cascading risk event based on the risk digital twin model. The preset influence distance may be preset based on experience.

The rescue equipment allocation status refers to equipment allocated to the rescue personnel of each rescue team and remaining rescue supplies thereof.

The distance between the rescue personnel and each of the plurality of individual risk events may be directly determined based on the occurrence location of the individual risk event and the rescue positioning data.

In some embodiments, the management platform may determine the rescue paths of the rescue personnel based on the detour region, the rescue equipment allocation status of the rescue personnel, and the distance between the rescue personnel and each of the plurality of individual risk events in a plurality of ways. For example, for each rescue team, the system determines a priority of each individual risk event for the rescue team based on the rescue equipment allocation status thereof and the distance between the rescue team and the individual risk event. The priority is obtained through a weighted summation after normalization processing of a risk type matching degree between the equipment allocated to the rescue personnel and the individual risk event, the remaining rescue supplies, and the distance between the rescue personnel and the individual risk event. The normalization processing includes Min-Max normalization, Z-score normalization, or the like. Weight coefficients for the risk type matching degree, the remaining rescue supplies, and the distance between the rescue personnel and the individual risk event may be preset based on experience.

A matching degree between the equipment allocated to the rescue personnel and a risk type of the individual risk event may be determined after determining standard rescue equipment for the individual risk event based on a fourth preset table by taking an overlap rate between the standard rescue equipment and the equipment allocated to the rescue personnel as the matching degree. The fourth preset table includes the standard rescue equipment corresponding to the individual risk event. For example, if the individual risk event is a fire, the standard rescue equipment includes at least a fire extinguisher.

For each rescue team, the management platform may take an occurrence location of an individual risk event with a highest priority as a target location for the rescue team to reach; and determine, based on a shortest path planning algorithm, a shortest path for the rescue team to reach the target location after bypassing a plurality of detour regions, where the shortest path is the rescue path. The shortest path planning algorithm includes a single-source shortest path (SSSP) algorithm, an all-pairs shortest path (APSP) algorithm, or the like.

The navigation instruction includes the navigation indication and the navigation color. The navigation indication includes a navigation direction arrow displayed by the indication device on the rescue path, and a textual identification corresponding to the navigation direction arrow. The navigation color refers to a display color of the navigation direction arrow. It should be noted that the display color of the lighting control instruction refers to a color (i.e., a lighting color) displayed by the display device as a whole, while the navigation color refers to a color of the navigation direction arrow displayed on the display device.

The direction arrow is configured to indicate a direction for the rescue personnel to reach based on the rescue path, and the textual identification is configured to distinguish whether the direction arrow is used for rescue.

By planning the rescue paths of the rescue personnel, bypassing the detour region, and matching the shortest rescue path with the rescue equipment for the event pending rescue, the rescue personnel can carry suitable rescue equipment and rapidly reach the occurrence location of the event, thereby improving rescue effectiveness.

The basic concepts have been described above. It is apparent to a person skilled in the art that the detailed disclosure described above is merely by way of example and does not constitute a limitation of the present disclosure. Although not explicitly stated herein, a person skilled in the art may make various modifications, improvements, and revisions to the present disclosure. Such modifications, improvements, and revisions are suggested in the present disclosure, and thus such modifications, improvements, and revisions are still within the spirit and scope of the exemplary embodiments of the present disclosure.

Furthermore, the present disclosure uses specific terms to describe the embodiments of the present disclosure. For example, expressions such as “an embodiment”, “one embodiment”, and/or “some embodiments” refer to a particular feature, structure, or characteristic related to at least one embodiment of the present disclosure. Therefore, it should be emphasized and noted that references to “one embodiment” or “an embodiment” or “an alternative embodiment” in various places in the present disclosure, occurring twice or more, do not necessarily refer to the same embodiment. In addition, certain features, structures, or characteristics in one or more embodiments of the present disclosure may be combined in a suitable manner.

Finally, it should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly presented and described in the present disclosure.

What is claimed is:

1. A system for emergency monitoring of hidden hazards in urban tunnels based on an Internet of Things (IoT) large model, wherein the system comprises an emergency supervision management platform, and the emergency supervision management platform is configured to:
obtain hazardous material monitoring data based on positioning devices deployed in a target tunnel;
determine a plurality of individual risk events in the target tunnel based on the hazardous material monitoring data, environmental monitoring data, and traffic monitoring data through a risk rule table;
determine cascading risk events in the target tunnel based on the plurality of individual risk events and structural information of the target tunnel; and
generate a first rescue instruction including rescue paths and rescue approaches based on the plurality of individual risk events and the cascading risk events, and control a corresponding rescue intelligent terminal to navigate along the rescue paths based on the first rescue instruction and display the rescue approaches.

2. The system according to claim 1, wherein the emergency supervision management platform is further configured to:
obtain a hazardous material transport vehicle identification based on the positioning devices deployed in the target tunnel; determine a plurality of associated vehicles based on the hazardous material transport vehicle identification and the hazardous material monitoring data;
for each of the plurality of associated vehicles, generate a prompt instruction including a recommended speed and a recommended distance based on the hazardous material transport vehicle identification; control an in-vehicle terminal of each of the plurality of associated vehicles to display the recommended speed and the recommended distance based on the prompt instruction; and
for a vehicle in an autonomous driving state located behind a hazardous material transport vehicle among the plurality of associated vehicles, when a distance between the vehicle in the autonomous driving state and the hazardous material transport vehicle is less than the recommended distance, generate a driving instruction; and control the vehicle in the autonomous driving state to decelerate based on the driving instruction.

3. The system according to claim 1, wherein the emergency supervision management platform is further configured to:
update the risk rule table every preset period based on historical hazardous material data, historical environmental data, and historical traffic data through a risk identification model; the risk identification model being a machine learning model.

4. The system according to claim 1, wherein the emergency supervision management platform is further configured to:
predict the cascading risk events in the target tunnel based on the plurality of individual risk events and the structural information through a prediction model; the prediction model being a graph neural network model.

5. The system according to claim 4, wherein the emergency supervision management platform is further configured to:
generate a ventilation control instruction including a ventilation speed and a ventilation direction based on the cascading risk events, the structural information, and a ventilation device distribution; and
control a corresponding jet fan to operate at the ventilation speed and in the ventilation direction based on the ventilation control instruction to ventilate the target tunnel.

6. The system according to claim 4, wherein the emergency supervision management platform is further configured to:
determine a high-risk region based on the plurality of individual risk events and the cascading risk events;
determine a crowd gathering point based on the traffic monitoring data;
generate a lighting control instruction including a display color and a flashing frequency based on the crowd gathering point and the high-risk region, and control a lighting device in a corresponding region to illuminate with the display color and flash at the flashing frequency based on the lighting control instruction; and
generate a lighting indication instruction including an indication sign based on the crowd gathering point and the high-risk region, and control a corresponding indication device to display the indication sign based on the lighting indication instruction.

7. The system according to claim 4, further comprising an emergency supervision user platform; wherein the emergency supervision management platform is further configured to:
construct a risk digital twin model based on the plurality of individual risk events, the structural information, the cascading risk events, and rescue positioning data; and
send the risk digital twin model to the emergency supervision user platform, and receive a second rescue instruction sent by the emergency supervision user platform.

8. The system according to claim 7, wherein the risk digital twin model further includes real-time environmental data; the emergency supervision management platform is further configured to:
determine a detour region based on the risk digital twin model during a rescue; the detour region including at least one of a region with abnormal real-time environmental data or a region associated with the cascading risk events;
determine the rescue paths of rescue personnel based on the detour region, a rescue equipment allocation status of the rescue personnel, and a distance between the rescue personnel and each of the plurality of individual risk events;
for each of the rescue paths, generate a navigation instruction including a navigation indication and a navigation color; and
control an indication device on the rescue path based on the navigation instruction to display the navigation indication in the navigation color.

9. A method for emergency monitoring of hidden hazards in urban tunnels based on an Internet of Things (IoT) large model, wherein the method is implemented by an emergency supervision management platform, and the method comprises:
obtaining hazardous material monitoring data based on positioning devices deployed in a target tunnel;
determining a plurality of individual risk events in the target tunnel based on the hazardous material monitoring data, environmental monitoring data, and traffic monitoring data through a risk rule table;
determining cascading risk events in the target tunnel based on the plurality of individual risk events and structural information of the target tunnel; and
generating a first rescue instruction including rescue paths and rescue approaches based on the plurality of individual risk events and the cascading risk events, and controlling a corresponding rescue intelligent terminal to navigate along the rescue paths based on the first rescue instruction and displaying the rescue approaches.

10. The method according to claim 9, further comprising:
obtaining a hazardous material transport vehicle identification based on the positioning devices deployed in the target tunnel; determining a plurality of associated vehicles based on the hazardous material transport vehicle identification and the hazardous material monitoring data;
for each of the plurality of associated vehicles, generating a prompt instruction including a recommended speed and a recommended distance based on the hazardous material transport vehicle identification; controlling an in-vehicle terminal of each of the plurality of associated vehicles to display the recommended speed and the recommended distance based on the prompt instruction; and
for a vehicle in an autonomous driving state located behind a hazardous material transport vehicle among the plurality of associated vehicles, when a distance between the vehicle in the autonomous driving state and the hazardous material transport vehicle is less than the recommended distance, generating a driving instruction; and controlling the vehicle in the autonomous driving state to decelerate based on the driving instruction.

11. The method according to claim 9, further comprising:
updating the risk rule table every preset period based on historical hazardous material data, historical environmental data, and historical traffic data through a risk identification model; the risk identification model being a machine learning model.

12. The method according to claim 9, further comprising:
predicting the cascading risk events in the target tunnel based on the plurality of individual risk events and the structural information through a prediction model; the prediction model being a graph neural network model.

13. The method according to claim 12, further comprising:
generating a ventilation control instruction including a ventilation speed and a ventilation direction based on the cascading risk events, the structural information, and a ventilation device distribution; and
controlling a corresponding jet fan to operate at the ventilation speed and in the ventilation direction based on the ventilation control instruction to ventilate the target tunnel.

14. The method according to claim 12, further comprising:
determining a high-risk region based on the plurality of individual risk events and the cascading risk events;
determining a crowd gathering point based on the traffic monitoring data;
generating a lighting control instruction including a display color and a flashing frequency based on the crowd gathering point and the high-risk region, and controlling a lighting device in a corresponding region to illuminate with the display color and flash at the flashing frequency based on the lighting control instruction; and
generating a lighting indication instruction including an indication sign based on the crowd gathering point and the high-risk region, and controlling a corresponding indication device to display the indication sign based on the lighting indication instruction.

15. The method according to claim 12, further comprising:
constructing a risk digital twin model based on the plurality of individual risk events, the structural information, the cascading risk events, and rescue positioning data; and
sending the risk digital twin model to an emergency supervision user platform, and receiving a second rescue instruction sent by the emergency supervision user platform.

16. The method according to claim 15, wherein the risk digital twin model further includes real-time environmental data; and the method further comprises:
determining a detour region based on the risk digital twin model during a rescue; the detour region including at least one of a region with abnormal real-time environmental data or a region associated with the cascading risk events;
determining the rescue paths of rescue personnel based on the detour region, a rescue equipment allocation status of the rescue personnel, and a distance between the rescue personnel and each of the plurality of individual risk events;
for each of the rescue paths, generating a navigation instruction including a navigation indication and a navigation color; and
controlling an indication device on the rescue path based on the navigation instruction to display the navigation indication in the navigation color 17. A non-transitory computer-readable storage medium, comprising computer instructions that, when executed by a computer, cause the computer to implement a method for emergency monitoring of hidden hazards in urban tunnels based on an Internet of Things (IoT) large model including:
obtaining hazardous material monitoring data based on positioning devices deployed in a target tunnel;
determining a plurality of individual risk events in the target tunnel based on the hazardous material monitoring data, environmental monitoring data, and traffic monitoring data through a risk rule table;
determining cascading risk events in the target tunnel based on the plurality of individual risk events and structural information of the target tunnel; and
generating a first rescue instruction including rescue paths and rescue approaches based on the plurality of individual risk events and the cascading risk events, and controlling a corresponding rescue intelligent terminal to navigate along the rescue paths based on the first rescue instruction and displaying the rescue approaches.
